(19) United States
(12) Patent Application Publication
(10) Pub. No.: US 2019/0329302 A1
(43) Pub. Date: Oct. 31, 2019

(54) CONDUIT DREDGE

(71) Applicant: Kuei-Kun WU, Kaohsiung City (TW)

(72) Inventor: Kuei-Kun WU, Kaohsiung City (TW)

(21) Appl. No.: 15/962,560

(22) Filed: Apr. 25, 2018

(51) Int. Cl. B08B 9/035

(52) U.S. Cl. CPC B08B 9/035; E03D 9/00

(57) ABSTRACT

A conduit dredge has a handle, a compression member, and a sealing member. The compression member is connected with an end of the handle, is hollow, is made of plastic, is compressible, and has a first end connected with the handle and a second end. The sealing member is connected with the second end of the compression member, is hollow, is made of rubber, and has a first end connected with the second end of the compression member, a second end, and a conical tubular segment formed on the second end of the sealing member.

### BACKGROUND OF THE INVENTION

### 1. Field of the Invention

The present invention relates to a conduit dredge and more particularly to an assembled conduit dredge.

### 2. Description of Related Art

When a conduit system is blocked by hairs or dirt, a conduit dredge is applied to clean the hairs or dirt. A conventional conduit dredge substantially comprises a handle and a suction member. The suction member is mounted on an end of the handle, is hollow, and is made of plastic.

To use the conventional conduit dredge, the suction member is mounted around an opening of a conduit system and is compressed repeatedly. With the suction member being compressed, a suction force is generated to suck the hairs or dirt out of the conduit system.

However, the suction member of the conventional conduit dredge is an integral element and is made of plastic, so the conventional suction member is relatively hard and is not easily deformed. Thus, the conventional suction member cannot provide a sealing effect to the surface defining the opening or of the opening, and the suction effect of the conventional conduit dredge is not sufficient. Furthermore, because the sealing effect of the conventional suction member is not sufficient, water in the conduit easily splashes to the user when the conventional conduit dredge is in operation. In addition, the suction member of the conventional conduit dredge cannot be applied to fit with different openings in different sizes or shapes and is not versatile in use.

To overcome the shortcomings, the present invention tends to provide a conduit dredge to mitigate or obviate the aforementioned problems.

### SUMMARY OF THE INVENTION

The main objective of the invention is to provide a conduit dredge that can be applied to different conduit systems having openings in different sizes or shapes and is versatile in use.

The conduit dredge has a handle, a compression member, and a sealing member. The compression member is connected with an end of the handle, is hollow, is made of plastic, is compressible, and has a first end connected with the handle and a second end. The sealing member is connected with the second end of the compression member, is hollow, is made of rubber, and has a first end connected with the second end of the compression member, a second end, and a conical tubular segment formed on the second end of the sealing member.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a conduit dredge in accordance with the present invention;

FIG. 2 is an exploded perspective view of the conduit dredge in FIG. 1;

FIG. 3 is a side view in partial section of the conduit dredge in FIG. 1;

FIG. 4 is an operational side view in partial section of the conduit dredge in FIG. 1;

FIG. 5 is a perspective view of a second embodiment of a conduit dredge in accordance with the present invention; and

FIG. 6 is a side view in partial section of the conduit dredge in FIG. 5.

### DETAILED DESCRIPTION OF PREFERRED EMBODIMENT

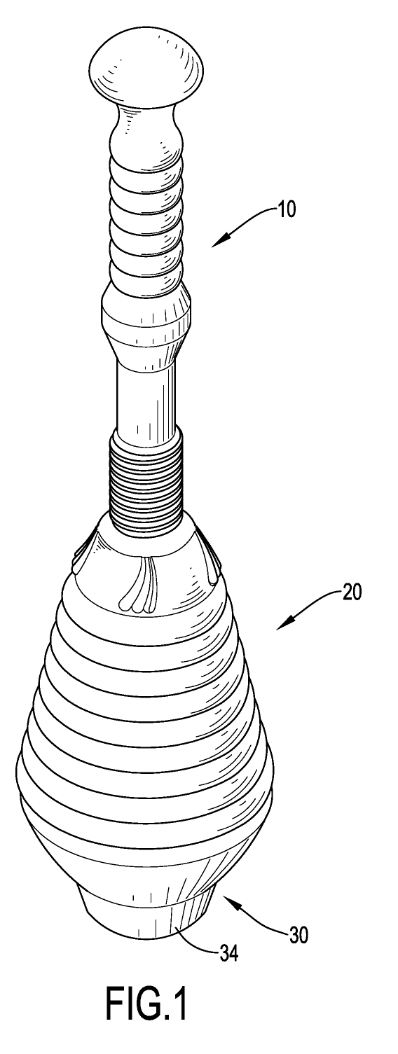

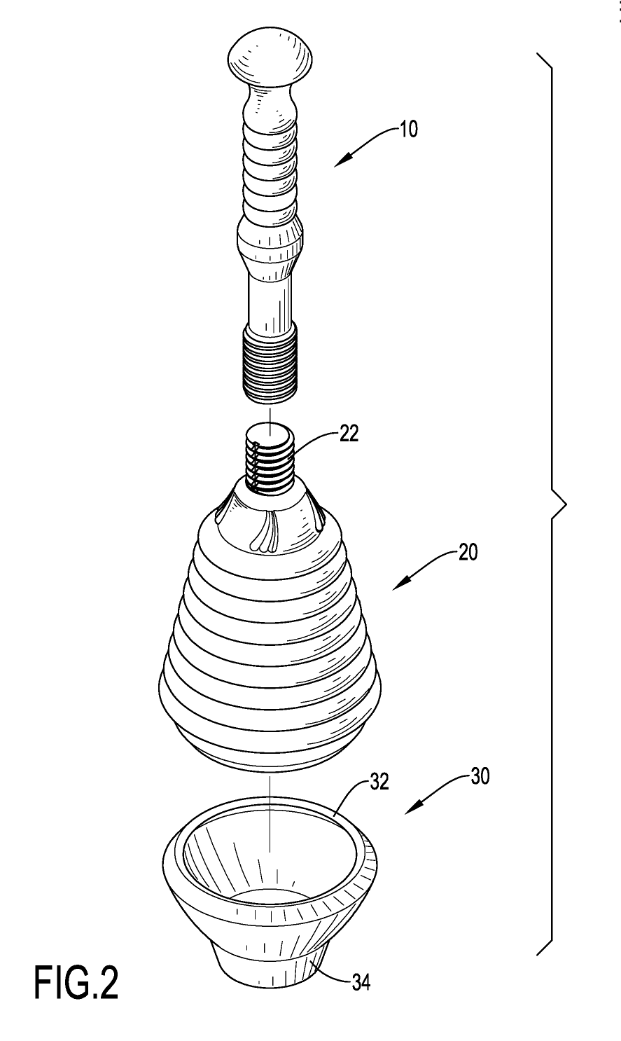

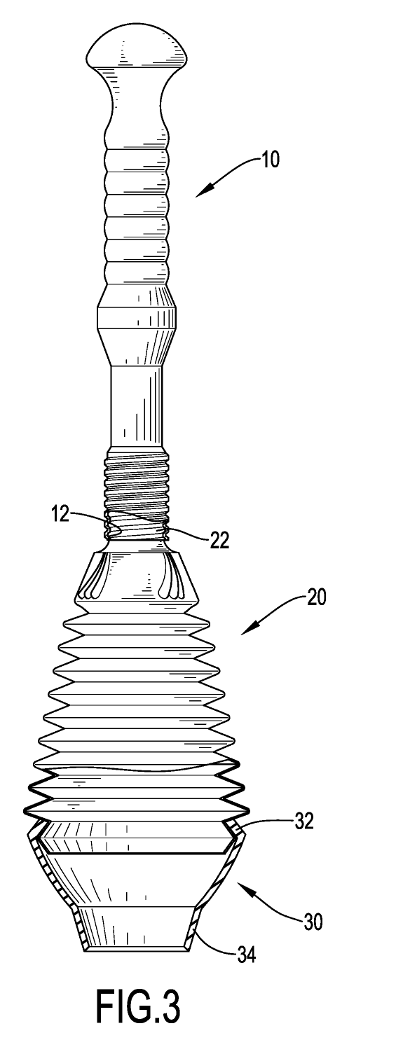

With reference to FIGS. 1 to 3, a conduit dredge in accordance with the present invention comprises a handle 10, a compression member 20, and a sealing member 30.

The handle 10 is elongated and has an end provided with a threaded hole 12. The compression member 20 is connected with the end of the handle 10, is hollow, is made of plastic, and is compressible. The compression member 20 has a first end, a second end, and a connecting rod 22. The connecting rod 22 is formed on and protrudes form the first end of the compression member 20 and is connected with the end of the handle 10. Preferably, the connecting rod 22 is threaded to screw with the threaded hole 12 in the handle 10. In addition, the compression member 20 may be conical and has a diameter gradually increasing from the first end to the second end. Preferably, the compression member 20 is pleated.

The sealing member 30 is connected with the second end of the compression member 20, is hollow, and is made of rubber. The sealing member 30 has a first end, a second end, and a connecting flange 32. The connecting flange 32 is formed on and protrudes inward from the first end of the sealing member 30 and is engaged with the second end of the compression member 20. Preferably, the connecting flange 32 is engaged with the lowermost pleat of the compression member 20. In addition, the sealing member 30 may be conical and has a diameter gradually decreasing from the first end to the second end. Preferably, the sealing member 30 may further have a conical tubular segment 34 formed on the second end of the sealing member 30.

When in use, the handle 10 is held by a user and the sealing member 30 is attached to or inserted into an opening of a conduit system, such as a toilet. The handle 10 is then pushed downward and pulled upward to compress and expand the compression member 20 repeatedly, such that a suction effect is provided into the conduit system to clean hairs or dirt in the conduit system. With the sufficient sealing effect provided by the sealing member 30, water in the conduit system can be kept from splashing to a user.

Because the sealing member 30 is made of rubber, the sealing member 30 is easily deformed to be completely in contact with the surface defining the opening or of the opening. Accordingly, an excellent sealing effect is provided between the sealing member 30 and the opening, so the suction effect provided by the conduit dredge is sufficient, leakage between the sealing member and the surface of the opening can be prevented, and the conduit dredge in accordance with the present invention is labor-saving in operation.

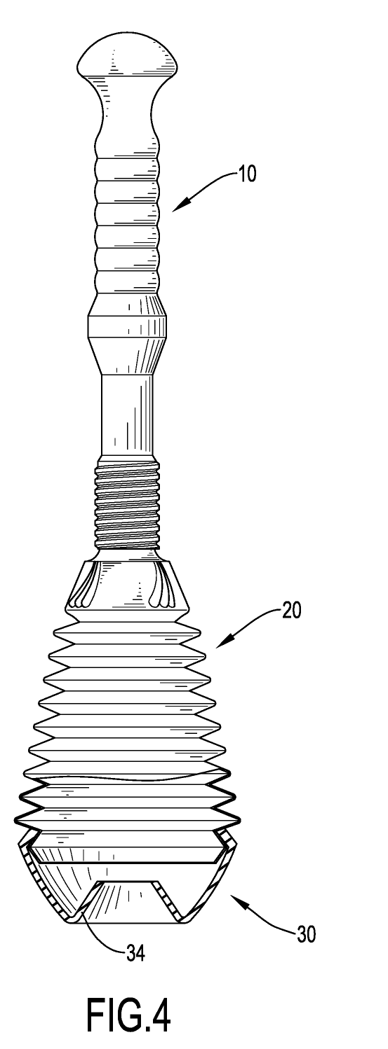

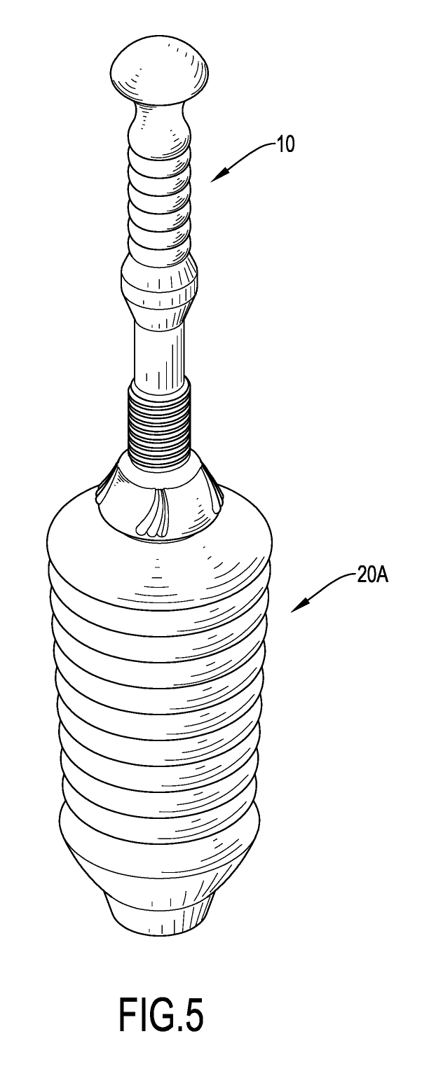

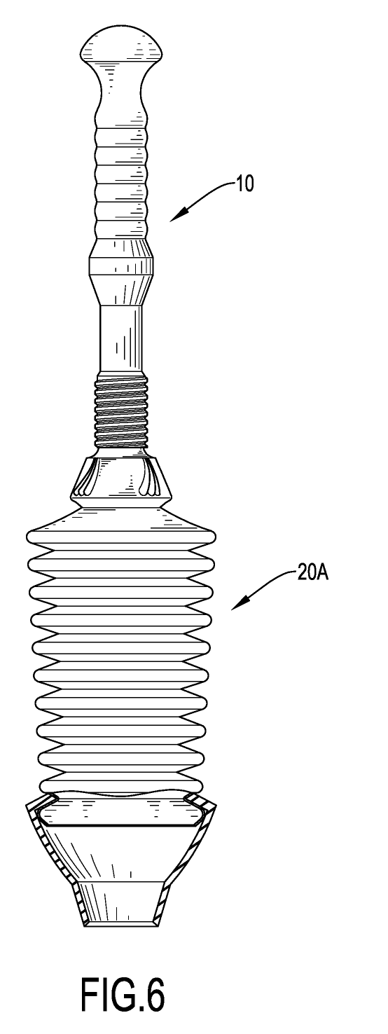

In addition, the rubber sealing member 30 is easily deformed to fit with openings in different sizes or shapes. With reference to FIG. 4, the conical tubular segment 34 of the sealing member 30 can be folded into the space in the sealing member 30, such that the folded end of the sealing member 30 can be mounted around an opening and be fully in contact with a surface defining an opening of a conduit system and provides an excellent sealing effect to the opening. Therefore, the conduit dredge in accordance with the present invention is versatile in use. With reference to FIGS. 5 and 6, in the second embodiment, the compression member 20A has a diameter gradually decreasing from the first end to the second end of the compression member 20A. Accordingly, the compression member 20A can extend through a narrow space, and the conduit dredge in accordance with the present invention can be operated in the narrow space.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A conduit dredge comprising:
a handle having an end;
a compression member connected with the end of the handle, being hollow, made of plastic, being compressible, and having a first end connected with the handle and a second end; and
a sealing member connected with the second end of the compression member, being hollow, made of rubber, and having a first end connected with the second end of the compression member, a second end, and a conical tubular segment formed on the second end of the sealing member.

2. The conduit dredge as claimed in claim 1, wherein the compression member has a connecting rod formed on the first end of the compression member and connected with the handle in a threaded manner.

3. The conduit dredge as claimed in claim 2, wherein
the handle has a threaded hole defined in the end of the handle; and
the connecting rod of the compression member is threaded and screwed with the threaded hole in the handle.

4. The conduit dredge as claimed in claim 3, wherein the compression member is pleated.

5. The conduit dredge as claimed in claim 4, wherein the compression member is conical and has a diameter gradually increasing from the first end to the second end.

6. The conduit dredge as claimed in claim 5, wherein the sealing member has a connecting flange formed on and protruding inward from the first end of the sealing member and engaged with a lowermost pleat of the compression member.

7. The conduit dredge as claimed in claim 4, wherein the compression member is conical and has a diameter gradually decreasing from the first end to the second end.

8. The conduit dredge as claimed in claim 7, wherein the sealing member has a connecting flange formed on and protruding inward from the first end of the sealing member and engaged with a lowermost pleat of the compression member.
